(19) United States
(12) Patent Application Publication
(10) Pub. No.: US 2002/0080169 A1
(43) Pub. Date: Jun. 27, 2002

(54) Method and system for determining a user profile

(76) Inventor: Elmo Marcus Attila Diederiks, Eindhoven (NL)

Correspondence Address: Michael E. Marion, c/o PHILIPS ELECTRONICS, NORTH AMERICA CORPORATION, 580 White Plains Road, Tarrytown, NY, 10591, US

(21) Appl. No.: 09/908,606

(22) Filed: Jul. 19, 2001

(30) Foreign Application Priority Data
Jul. 21, 2000 (EP) 00202643.3

(51) Int. Cl. G09G 5/00

(52) U.S. Cl. 345/744; 345/811

(57) ABSTRACT

In television receivers and similar systems, user profiles (301, 302, 303, 311, 312, 313, 321, 322, 323) are needed for use with interactive agents which suggest or recommend content. The invention relates to a method and system for determining a user profile for a user. A first set (30) of profiles is presented, from which the user makes a selection. Next “generations” (31, 32) of profiles are created based upon previous ones, preferably using a genetic algorithm. Each next generation (31, 23) will be more suited to the user's preferences, because the relevant attributes are passed on to this next generation. Presentation of the profiles can be adapted to the attributes, so that the user can visually recognize each profile and make a more informed selection.

The invention relates to a method of determining a user profile for a user.

The invention further relates to a system for determining a user profile for a user.

Television receivers, set-top boxes and similar systems often comprise an electronic program guide (EPG) which is capable of receiving and decoding program data, such as a program title or program category, related to programs which will be transmitted in the near future. Generally, such an EPG shows a list of program titles and the clock-times, indicating at which time and by which channel the programs will be transmitted. The user interface in the known method and system has the feature of keeping record of the users' preferences and interest. This kind of interest can be stored in a so-called user profile for a user. A user profile contains several attributes, which can have values indicating the user's interest, lifestyle, and so on. A possible way of visualizing such a profile is the use of a visual agent. Such an agent can give advice, suggest programs or help in another way to let the user find information of interest.

When a large number of channels and programs are available, it becomes difficult for a user to find the program he is interested in. To assist the user, the above-mentioned system and method employ an agent which is capable of examining the EPG to find programs that are of interest to the user, according to his user profile. However, this only works well if the user profile matches the user. When the user has only recently started using the system, there is little information from which to build a user profile. Therefore, these systems are often provided with starting profiles, which match average users from different population groups. For example, there could be a starting profile matching kids aged 12-16 years, one matching people interested in history or nature, and one matching sports lovers.

When the user first uses the system, he is asked to select a starting profile which best matches him. The starting profile is then used as his user profile, and adapted in accordance with his viewing behavior when he uses the system. In other words, the system learns from his viewing behavior and adjusts the user profile accordingly. To select a starting profile, the user either has to choose from a small number of very generic profiles, or from a large number of specific profiles. The generic profiles are almost always too broad, so it takes a long time for them to be adapted to the viewing behavior of the user. However, the alternative of presenting a large number of specific profiles, which more closely match smaller and better-defined user groups, makes the selection mechanism unwieldy and hard to use. This is especially true on television receivers, which only have limited screen space available to present user profiles for selection.

It is an object of the invention to provide a method according to the preamble, which is easy and intuitive to use and results in a user profile which is a good match for the user.

This object is achieved in a method comprising the steps of

(a) generating a first generation of profiles;

(b) presenting the current generation of profiles to the user;

(c) receiving a user selection of one or more profiles from the current generation;

(d) if the user selection comprises exactly one profile,

determining the user profile as the exactly one profile, and otherwise

generating a next generation of profiles from the selection,

and executing steps (b), (c) and (d) for this next generation of profiles.

A generation of profiles is a collection of profiles which are somehow related. The method according to the invention starts with a first generation of rather generic profiles, and then uses the selection provided by the user to generate subsequent generations of profiles, which are more specific. The next generation is derived from the previous generation, for example, by combining attributes from profiles of the previous generation to obtain new profiles, or by varying attribute values. The current generation, that is, the generation which is generated most recently, is presented to the user. When the user selects one profile from the current generation, he indicates that this profile best matches him, and so this is used as his user profile from then on. If he chooses more than one profile, a next generation is obtained from the selection made from the current generation, and this next generation is then presented to the user. Since each generation only has a small number of profiles, the user can easily examine them all. A selection results in more profiles that resemble the selected profile, which is intuitive behavior for such a method.

In an embodiment the next generation of profiles is generated using a genetic algorithm. An advantage of this embodiment is that genetic algorithms are well suited for situations like this. With a genetic algorithm, where attributes of profiles can be represented as genes, attributes can be inherited by “child profiles” from their “parent profiles”. This provides next generation profiles which resemble the previous generation.

In a further embodiment the next generation of profiles is generated from a combination of values of attributes of the profiles of the current generation. An advantage of this embodiment is that combining the values in this fashion is easy to implement, and gives satisfactory results.

It is a further object of the invention to provide a system according to the preamble, which is easy and intuitive to use and results in a user profile which is a good match for the user.

This object is achieved in a system comprising

initialization means for generating a first generation of profiles;

presentation means for presenting the current generation of profiles to the user;

receiving means for receiving a user selection of one or more profiles from the current generation;

generation means for determining if the user selection comprises exactly one profile, and if so determining the user profile as the exactly one profile, and otherwise generating a next generation of profiles from the current generation, and activating the presentation means.

The initialization means generate a first generation with which the user can start the selection process. He is then repeatedly presented with a generation of profiles, chooses one or more profiles, and depending on his choice, he gets a next generation or his chosen profile is used as his user profile.

In an embodiment the initialization means are arranged to determine values of attributes of the profiles of the first generation in a pseudo-random fashion. An advantage of this embodiment is that this gives a variation in the first generation of profiles. If a user cannot find any suitable profiles in the first generation, he can restart the system and he will then be provided with a different set of first generation profiles.

In a further embodiment the generation means are arranged to generate the next generation of profiles using a genetic algorithm. An advantage of this embodiment is that genetic algorithms are well suited for situations like this. With a genetic algorithm, where attributes of profiles can be represented as genes, attributes can be inherited by “child profiles” from their “parent profiles”. This provides next generation profiles which resemble the previous generation.

In a further embodiment the generation means are arranged to generate the next generation of profiles from a combination of values of attributes of the profiles of the current generation. An advantage of this embodiment is that combining the values in this fashion is easy to implement, and gives satisfactory results.

In a further embodiment the generation means are arranged to determine if the user selection comprises exactly one profile, and the number of generations previously generated exceeds a predetermined number, and if so, to determine the user profile as the exactly one profile, and otherwise to generate a next generation of profiles from the current generation, and activating the presentation means. An advantage of this embodiment is that if a user chooses a single profile from an early generation, this profile may still be very generic. It is then advisable that the user selects multiple profiles instead, so better suited profiles can be generated. By keeping track of the generation count, and only allowing selection of a single profile after the generation count has exceeded a certain value, the user can only select a single profile if it is specific enough.

In a further embodiment the presentation means are arranged to adapt the presentation of a profile of the current generation based on values of attributes of the profile. An advantage of this embodiment is that this allows for easy recognition and examining of the profile presented in this fashion. For example, if an attribute indicating the gender of the user has the value “male”, then the presentation could be adapted to show a male figure. If another attribute indicates that the user is a soccer lover, then the presentation of the profile could be further adapted to show a male figure wearing soccer attire. This way, the user can immediately recognize that that profile matches him in those two aspects.

The invention further relates to a television receiver comprising a system according to the invention.

The invention further relates to a computer program product enabling a programmable device to function as a system according to the invention.

These and other aspects of the invention will be apparent from and elucidated with reference to the embodiments shown in the drawing, in which:

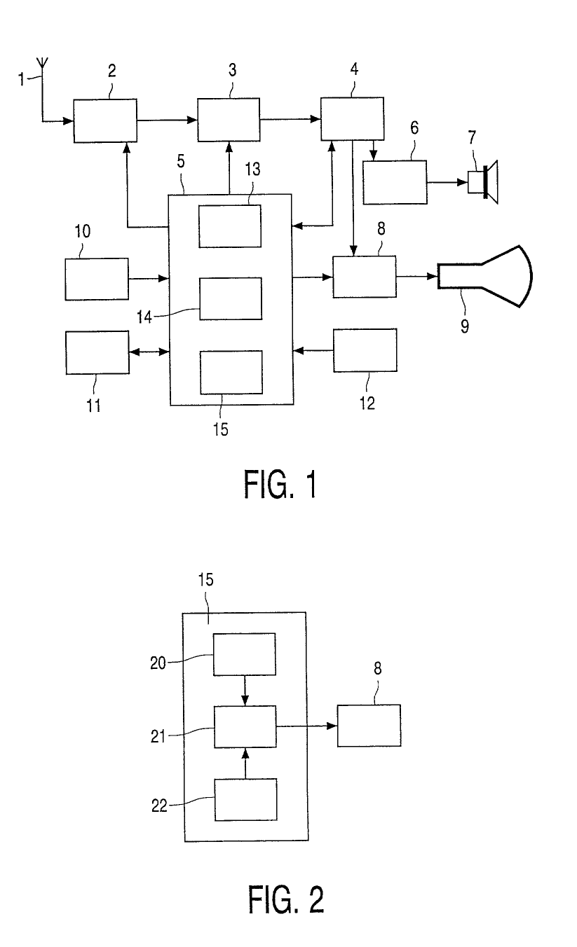

FIG. 1 schematically shows a television receiver comprising a system according to the invention;

FIG. 2 schematically shows an embodiment of a system according to the invention; and

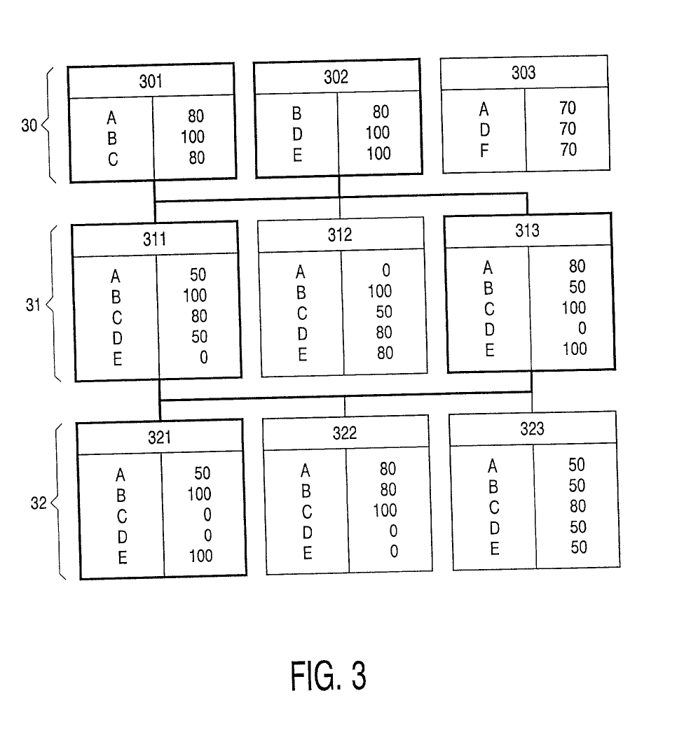

FIG. 3 shows a schematic overview of a number of generations of profiles.

Throughout the figures, same reference numerals indicate similar or corresponding features. Some of the features indicated in the drawings are typically implemented in software, and as such represent software entities, such as software modules or objects.

FIG. 1 schematically shows a television receiver comprising a system according to the invention. Digital broadcast streams, modulated upon radio frequency (RF) signals, are received from the ether by an antenna 1, or, alternatively, from a cable network. The broadcast streams may be formatted, for example, in accordance with the Digital Video Broadcasting (DVB) standard. A tuner 2 comprises a standard analog RF receiving device which is capable of receiving said RF signals and selecting one of them to be output to a demodulator 3. Which signal the tuner 2 is depending upon control data received from a central processing unit (CPU) 5. The demodulator 3 converts the analog signal into a digital packet stream, based on the control signals received from the CPU 5. This packet stream is then output to a demultiplexer 4, which selects packets belonging to a particular program in accordance with control data received from the CPU 5, and decomposes the packet stream into elementary audio, video or data streams.

In addition to broadcast signals, the television receiver may be adapted to receive signals from other sources too, for example, from a (digital) video recorder or DVD player, from the internet, or from a digital subscriber line. Programs and program attributes need not be obtained from the same source. For example, attribute and attribute values relating to broadcast programs may be obtained from an internet site.

A video processor 8 decodes the video stream received from the demultiplexer 4 or from the CPU 5. Decoded video data is then transmitted to a display screen 9. An audio processor 6 decodes the audio stream received from the demultiplexer 4. Decoded audio data is then transmitted to a speaker system 7.

The demultiplexer 4 outputs the elementary data stream to the CPU 5. The elementary data stream has two types of data: control data and content data. Content refers to, for example, interactive programs; control refers to tables in the multiplex which specify matters like the structure of the multiplex, the (RF) frequencies at which the channels are modulated, and the addresses at which the various content components and the (other) tables in the multiplex can be found. The CPU 5 comprises one or more microprocessors capable of executing program instructions stored in a read-only memory (ROM) 12. These program instructions comprise parts of software modules including, inter alia, a command module 13, and a user profile module 14. Data processed by said software modules, e.g. DVB-SI data and user profile information, may be stored in a non-volatile memory 11. The command module 13 is capable of controlling functions of the television receiver, like tuning and demultiplexing a selection, and transmitting data to the video processor 8 to be presented on the screen 9. A user command unit 10 receives user commands, e.g. through a remote control (not shown), and transmits them to the command module 13 to be processed. For example, when the user enters a channel number, the command module 13 controls the tuner 2 and the demultiplexer 4 to select the corresponding broadcast stream and data packets therein, and sends graphical data to the video processor 8 to present feedback on the screen 9, e.g. the present number, the channel name being displayed for a few seconds. The user profile module 14 interprets the DVB-SI data received from the demultiplexer 4 to collect information about the channels, or “services” in DVB terminology, which are available in the received broadcast streams and about the programs, or “events” in DVB terminology, which are scheduled for those channels. The user profile module 14 may be arranged to learn from the user's viewing behavior. For example, the user profile module 14 could receive the commands from the command module 13 and determine from that which programs the user finds interesting. The television receiver further comprises a user profile selection module (UPSM) 15 in the CPU 5. When a user first uses the television receiver, or explicitly activates this module 15, he is asked to select a user profile. The workings of this UPSM 15 will be explained in more detail with reference to FIG. 2 below.

FIG. 2 schematically shows an embodiment of the user profile selection module (UPSM) 15, comprising initialization means 20, presentation means 21 and generation module 22. When the UPSM 15 is activated, the initialization module 20 generate a first generation of profiles, for example by initializing attributes of profiles with pseudo-random values, or by loading a default set of profiles from non-volatile memory 11, or obtaining them from an external source, such as the internet. The non-volatile memory 11 can also contain a number of predetermined values for use in initializing the attributes. A generation of profiles is a set of profiles that are somehow related. A profile comprises a number of attributes and values, preferably also with a description of what an attribute signifies. As will become apparent below, the UPSM 15 generates multiple generations of profiles. Each generation is related to its parent generation. The term “current generation” is used to refer to the generation which is generated most recently. The number or profiles in a generation is not necessarily limited, but should be chosen so that the user can easily examine them all at once easily. For a television receiver, six profiles, presented in two rows of three presentations, would be an appropriate option. The number should be chosen so that scrolling the presentation is unnecessary, as this makes the system less intuitive to the user. However, care should be taken not to use a very small number of profiles, as these will then be too generic, requiring many generations to be generated before a sufficiently specific profile can be selected.

After being generated, the first generation of profiles is fed to the presentation module 21, which creates a presentation for the profiles of this generation. This presentation is then fed to the video processor 8, which is arranged to display the presentation on the screen 9 so the user can view them. This presentation is preferably visual, for easy recognition and distinguishing of the profiles. The presentation of a profile is preferably adapted to the values of attributes of the profile. For example, of an attribute indicating the gender of the user has the value “male”, the presentation could be adapted to show a male figure. If another attribute has a value indicating the user likes soccer, the representation of the male figure could be further adapted so it is shown wearing soccer attire. The graphics necessary to generate such adaptive presentations could all be stored in non-volatile memory 11, but as this may require a large amount of memory, they could also be downloaded e.g. from the internet when they are necessary. In that case, a known caching mechanism could be provided to prevent unnecessary downloading.

After the current generation of profiles has been presented on the screen 9, the user is asked to select one or more of them. The selection could be limited by the system to for example half of the profiles, as selecting more than that many will give little information and prevent the generation of a next generation of profiles which is well suited to the user. The user can use his remote control (not shown) or some other input device to make a selection. The user command unit 10 receives the selection and communicates it to the generation module 22.

The generation means 22 first checks if the user selection comprises exactly one profile. If so, this one profile is selected as the user profile for the user and it is fed to the user profile module 14. It may be advantageous to do this only if the generation to which the selected profile belongs is sufficiently specific. To this end, a generation count should then be recorded for each generation, and the one user profile should be from a generation having a sufficiently high generation count. For example, it should be from at least a third generation of profiles. If the selected one user profile is from a first or second generation, the selection is rejected and the user is asked to select more than one profile.

If the user selections more than one profile from the current generation, or, in the case a generation count is kept, the generation count of the current generation is too low, the generation module 22 generates a next generation of profiles from the selection. The generation module 22 can for instance use a genetic algorithm to this end, by feeding the selected profiles as input and obtaining the next generation as output. Alternatively, a combination of attribute values can be made from the selected profiles to obtain the next generation. In that case, some attributes should be added to and mixed between profiles. This generates new profiles which are sufficiently different between generations. Other algorithms to generate new profiles from the selections can also be used.

Values of attributes can be changed between generations. For example, if many selected profiles have a high value for some attribute, the next generation may all have high values for that attribute as well, but each profile of the next generation may still have a different high value. Using pseudo-random variations, preferably within some bounds, is also possible.

When the next generation of profiles has been generated, it is fed to the presentation module 21, which creates a presentation for this generation as described above. In this way, the current generation will bear similarities to its “parent” generation, so that to the user the presentation of generations is clearer. This makes the workings of the UPSM 15 more intuitive.

The user can then again select one or more profiles from the current generation. Said selection is then processed as described above. This process will repeat until the user selects exactly one profile or aborts the process altogether, for example by switching the television receiver off or by using some abort command. The UPSM 15 could have an upper limit on the number of generations thusly generated. When this limit is reached, the user is forced to choose exactly one profile. The UPSM 15 could save a number of previously generated generations, so that the user can go back to a previous generation, for example if the current generation does not provide him with any suitable profiles.

To illustrate the principle of generations of profiles, FIG. 3 shows a schematic overview of three generations 30, 31, 32 of profiles. Generation 32 is the current generation. The first generation 30 comprises profiles 301, 302, 303, whose attribute values are generated in a pseudo-random fashion. The user has selected profiles 301 and 302 from the first generation 30. The bold border around these profiles 301, 302 indicates this. The generation module 22 has generated the second generation 31 based on this selection, said second generation 31 comprising profiles 311, 312, 313. From this generation, the user has selected profiles 311 and 313, again indicated by a bold border. The current generation 32 has been generated from this selection and comprises profiles 321, 322, 323. The user has selected the one profile 321, which can now be used as his user profile.

The profiles 301, 302, 303, 311, 312, 313, 321, 322, 323 have one or more attributes, indicated by letters A through F. Each attribute A-F has a value, shown as a number in FIG. 3, but of course the value can be anything. The first generation 30 only uses a small number of attributes, making profiles 301, 302, 303 very generic, but the second and third generations 31, 32 have more attributes and so are more specific. Note that attribute F, present in profile 303 from the first generation 30, is not present in any of the profiles from the second generation 31. This happened because the user did not select profile 303, and neither profile 301 or 302 contains this attribute F. The generation module 22 therefore concluded that attribute F is not of interest to the user.

The value of the attributes A-E, which for the same reasoning as above are of interest to the user, are varied amongst the profiles 310, 311, 312 of the second generation 31. The current generation 32 has been generated using the same algorithm. Note that values once again vary throughout the profiles 321, 322, and 323. If it is known that, for example, a high value of attribute A implies a high value for attribute B, then the value of attribute B should be adjusted if the value of attribute A is found to be high. For example, if attribute A indicates the gender of the user, then a value of “male” could be used as an indicator that the attribute value indicating an interest in soccer should be increased.

For reasons of simplicity, the presentation of the profiles 301, 302, 303, 311, 312, 313, 321, 322, 323 in FIG. 3 is not graphical. In practice, as described above, the values of the attributes A-F would preferably be used for each profile to create a visual representation of some kind that is adapted to this value.

1. A method of determining a user profile (321) for a user, comprising the steps of
(a) generating a first generation (30) of profiles;
(b) presenting the current generation (30, 31, 32) of profiles to the user;
(c) receiving a user selection of one or more profiles from the current generation (30, 31, 32);
(d) if the user selection comprises exactly one profile,
determining the user profile (321) as the exactly one profile, and otherwise
generating a next generation (31, 32) of profiles from the current generation (30, 31, 32),
and executing steps (b), (c) and (d) for this next generation of profiles.

2. The method of claim 1, where the next generation of profiles is generated using a genetic algorithm.

3. The method of claim 1, where the next generation (31, 32) of profiles is generated from a combination of values of attributes of the profiles of the current generation.

4. A system for determining a user profile (321) for a user, comprising
initialization means (20) for generating a first generation (30) of profiles;
presentation means (21) for presenting the current generation (30, 31, 32) of profiles to the user;
receiving means (10) for receiving a user selection of one or more profiles from the current generation (30, 31, 32);
generation means (22) for determining if the user selection comprises exactly one profile, and if so determining the user profile (321) as the exactly one profile, and otherwise generating a next generation (31, 32) of profiles from the current generation (30, 31, 32), and activating the presentation means (21).

5. The system of claim 4, where the initialization means (20) are arranged to determine values of attributes (A-F) of the profiles (301, 302, 303) of the first generation (30) in a pseudo-random fashion.

6. The system of claim 4, where the generation means (22) are arranged to generate the next generation (31, 32) of profiles using a genetic algorithm.

7. The system of claim 4, where the generation means (22) are arranged to generate the next generation (31, 32) of profiles from a combination of values of attributes (A-F) of the profiles of the current generation (30, 31, 32).

8. The system of claim 4, where the generation means (22) are arranged to determine if the user selection comprises exactly one profile, and the number of generations previously generated exceeds a predetermined number, and if so, to determine the user profile as the exactly one profile, and otherwise to generate a next generation of profiles from the current generation, and activating the presentation means (21).

9. The system of claim 4, where the presentation means (21) are arranged to adapt the presentation of a profile of the current generation based on values of attributes (A-F) of the profile.

10. Television receiver comprising a system as defined in claim 4.

11. A computer program product enabling a programmable device when executing said computer program product to function as a system as defined in claim 4.
